(19) United States
(12) Patent Application Publication
(10) Pub. No.: US 2006/0023834 A1
(43) Pub. Date: Feb. 2, 2006

(54) High voltage transformer for backlight power source

(75) Inventors: Cheng-Chia Hsu, Chupei City (TW); Teng-Kang Chang, Jhudong Township (TW)

Correspondence Address: HDSL, 4331 STEVENS BATTLE LANE, FAIRFAX, VA, 22033, US

(73) Assignee: Logah Technology Corp.

(21) Appl. No.: 11/187,842

(22) Filed: Jul. 25, 2005

(30) Foreign Application Priority Data
Jul. 28, 2004 (TW) 093211935

(51) Int. Cl. G01N 23/223

(52) U.S. Cl. 378/44

(57) ABSTRACT

A high voltage transformer for a backlight power source includes a windings base, a core and windings, the windings base having isolating walls disposed exterior thereto through which a primary side region and a secondary side region are formed, the secondary side region being optionally formed with several windings troughs by using of the isolating walls and the windings being wound on the windings troughs, the windings being wound upward layer by layer on a bottom of the windings trough when the windings are wound across the isolating walls in prevention of the windings of different voltages flown therein crossing and contacting with each other and fixed onto a windings fixation post after the windings troughs are full, and the core being received within a hollow structure of the windings base. As such, distance generated from stacking of the windings is served to increase the bearing voltage and reduce length of the transformer.

### BACKGROUND OF THE INVENTION

1. Field of the Invention

The present invention relates to a high voltage transformer for a backlight power source, and more particularly to a high voltage transformer for a backlight power source in which windings may be wound upward layer by layer on a bottom of a windings trough, which is facilitated by a novel structural design of a windings base when the windings are wound across an isolating wall so that a voltage bearing ability and stability of the high voltage transformer is enhanced.

2. Description of the Related Art

FIGS. 1A, 1B and 1C are respectively a side view, partial view and partial side view of a conventional transformer. As shown, the transformer 1 is composed of a windings base 11, a core and windings 13. Exterior to the windings base 11, a plurality of isolating walls 111 are disposed, through which a primary side region 14 and a secondary side region 15 are formed. Through the isolating walls 111, the secondary side region 15 is further divided into a multitude of windings troughs 16 in which the windings 13 are disposed in turn.

Within a hollow structure of the windings base 11, the core 12 is received. As such, formation of the transformer 1 is completed. Since the transformer 1 has to meet the requirement of voltage bearing, the plurality of troughs are provided to isolated the voltage. However, since the isolating walls 111 are too high and thin (typically 0.4 mm in thickness), distance between two such adjacent troughs 16 is insufficient, leading to an insufficient voltage bearing ability of the troughs 16. On the other hand, when windings 13 are intended to be lain out through a recess 112 onto another windings trough 16, the windings may not be wound on the windings trough 16 from a bottom thereof. This causes windings 13 of different voltages flown therein to contact and thus the voltage bearing ability is reduced. In this case, characteristics of the transformer 1 are unstable and exception would generally occur. In response to this problem, more windings troughs are generally suggested. However, issues of cost, dimension and layout space may be additionally involved in this design.

From the above discussion, it can be readily known that such conventional transformer is inherent with some drawbacks and needs to be addressed and improved.

In view of these problems encountered in the prior art, the Inventors have paid many efforts in the related research and finally developed successfully a high voltage transformer for a backlight power source, which is taken as the present invention.

### SUMMARY OF THE INVENTION

Therefore, the present invention is to provide a high voltage transformer for a backlight power source in which windings may be wound upward layer by layer on a bottom of a windings trough, which is facilitated by a novel structural design of a windings base, when the windings are wound across an isolating wall, in prevention of windings of different voltages flown therein crossing and contacting with each other and thus a reduced voltage bearing ability of the transformer.

Another, the present invention is to provide a high voltage transformer for a backlight power source in which distance generated from stacking of the windings is served to increase the bearing voltage and reduce length of the transformer, enhancing stability of the transformer.

Still another, the present invention is to provide a high voltage transformer for a backlight power source having the advantages of prolonged lifetime, lower cost, reduced dimension and space saving of the transformer.

The high voltage transformer for a backlight power source according to the present invention is composed of a windings base, a core and windings. Exterior to the windings base, isolating walls are disposed, through which a primary side region and a secondary side region are formed. In the secondary side region, the isolating walls may be optionally utilized to form several windings troughs on which the windings are wound. Within a hollow structure of the windings base, the core is disposed. With the novel structural design of the windings base, when the windings are wound across the isolating wall, the windings may be wound upward layer by layer on a bottom of the windings trough in prevention of windings of different voltages flown therein crossing and contacting with each other and thus the reduced voltage bearing ability of the transformer.

### BRIEF DESCRIPTION OF THE DRAWINGS

The drawings disclose an illustrative embodiment of the present invention which serves to exemplify the various advantages and objects hereof, and are as follows:

FIG. 1A is a side view of a conventional transformer;

FIG. 1B is a partial view of the conventional transformer;

FIG. 1C is a partial side view of the conventional transformer;

FIG. 2A is a perspective view of a high voltage transformer for a backlight power source according to a first embodiment of the present invention;

FIG. 2B is a side view of the high voltage transformer for a backlight power source according to the first embodiment of the present invention;

FIG. 3A is a perspective view of the high voltage transformer for a backlight power source according to a second embodiment of the present invention;

FIG. 3B is a side view of the high voltage transformer for a backlight power source according to the second embodiment of the present invention;

FIG. 4A is a side view of the high voltage transformer for a backlight power source according to a third embodiment of the present invention;

FIG. 4B is a partial view of the high voltage transformer for a backlight power source according to the third embodiment of the present invention;

FIG. 4C is a partial side view of the high voltage transformer for a backlight power source according to the third embodiment of the present invention;

FIG. 5A is a partial view of the high voltage transformer for a backlight power source according to a fourth embodiment of the present invention;

FIG. 5B is a partial side view of the high voltage transformer for a backlight power source according to the fourth embodiment of the present invention;

FIG. 6A is a partial view of the high voltage transformer for a backlight power source according to a fifth embodiment of the present invention;

FIG. 6B is a partial side view of the high voltage transformer for a backlight power source according to the fifth embodiment of the present invention;

FIG. 7A is a partial view of the high voltage transformer for a backlight power source according to a sixth embodiment of the present invention;

FIG. 7B is a partial side view of the high voltage transformer for a backlight power source according to the sixth embodiment of the present invention;

FIG. 8 is a partial view of the high voltage transformer for a backlight power source according to a seventh embodiment of the present invention;

FIG. 9A is a partial view of the high voltage transformer for a backlight power source according to an eighth embodiment of the present invention;

FIG. 9B is a partial side view of the high voltage transformer for a backlight power source according to the eighth embodiment of the present invention;

FIG. 10 is a partial view of the high voltage transformer for a backlight power source according to a ninth embodiment of the present invention; and

FIG. 11 is a partial view of the high voltage transformer for a backlight power source according to the tenth embodiment of the present invention.

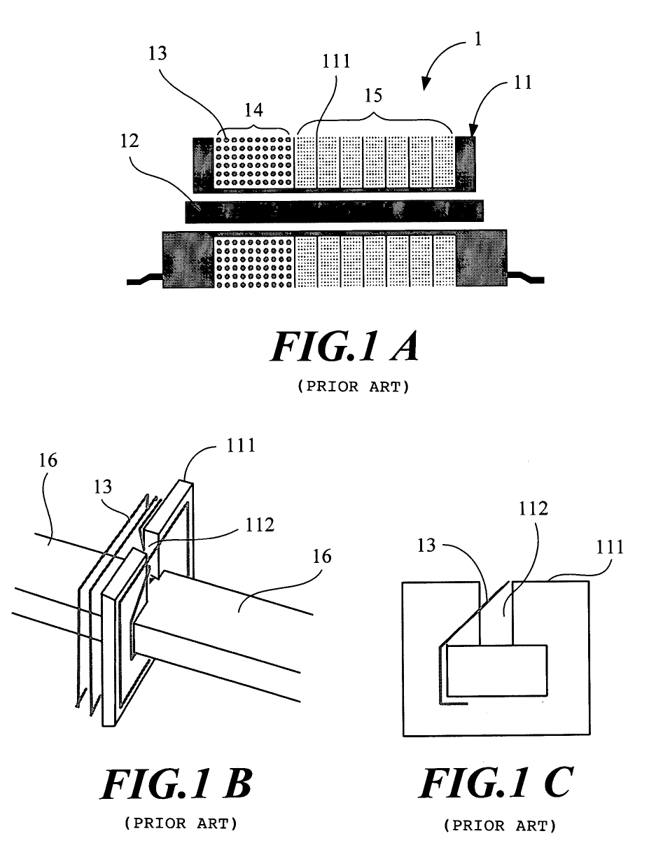

### DETAILED DESCRIPTION OF THE PREFERRED EMBODIMENT

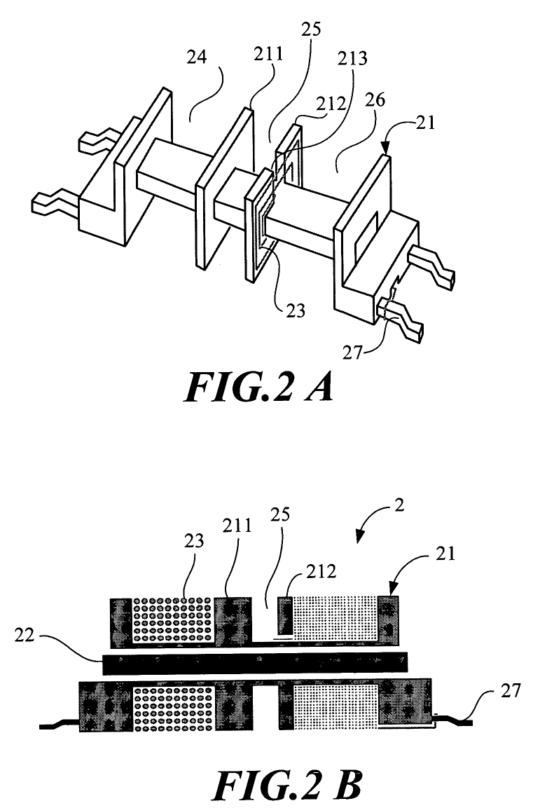

Referring to FIGS. 2A and 2B, a perspective view and side view of a windings base of a high voltage transformer for a backlight power source according to a first embodiment of the present invention are illustrated, respectively. As shown, exterior to the windings base 21, isolating walls 211,212 are disposed, through which a first windings trough 24, a spare trough 25 and a second windings trough 26 are formed. In laying out the windings 23, the windings 23 are wound first on a bottom of the first windings trough 24 at a primary side region and then stridden on the spare trough 25 after the first windings trough 24 is full. Then, the windings 23 are guided onto the second windings trough 26 at a secondary side region through a recess 213 formed on the isolating wall 212. Thereafter, the windings 23 are wound upward on a bottom of the second windings trough 26 layer by layer until the second windings trough 26 is full. Finally, the windings 23 are fixed onto a windings fixation post 27. As such, the windings 23 of different voltages flown therein may be prevented from crossing and contacting with each other when being wound from one trough to an adjacent trough. Then, the core 22 is disposed within a hollow structure of the windings base 21 and the high voltage transformer 2 is thus completely formed.

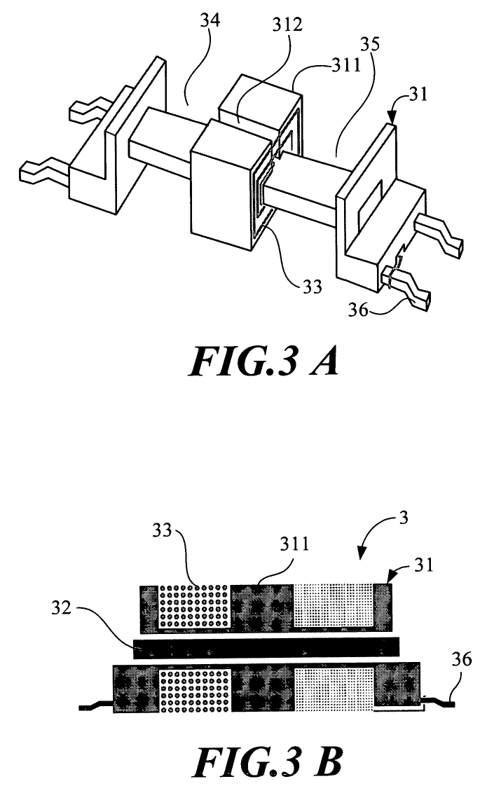

Referring to FIGS. 3A and 3B, a perspective view and side view of a windings base of the high voltage transformer for a backlight power source according to a second embodiment of the present invention are illustrated, respectively. As shown, the transformer 3 is composed of a windings base 31, a core 32 and windings 33. Exterior to the windings base 31, a thick isolating wall 311 is disposed, through which a first windings trough 34 and a second windings trough 35 are formed. In laying out the windings 33, the windings 33 are wound first on a bottom of the first windings trough 34 at a primary side region and then stridden onto the second windings trough 35 at a secondary side region through a recess 312 formed on the thick isolating wall 311. Thereafter, the windings 33 are wound upward on a bottom of the second windings trough 35 layer by layer until the second windings trough 35 is full. Finally, the windings 33 are fixed onto a windings fixation post 36. As such, the windings 33 of different voltages flown therein may be prevented from crossing and contacting with each other when being wound from one trough to an adjacent trough. Then, the core 32 is disposed within a hollow structure of the windings base 31 and the high voltage transformer 2 is thus completely formed.

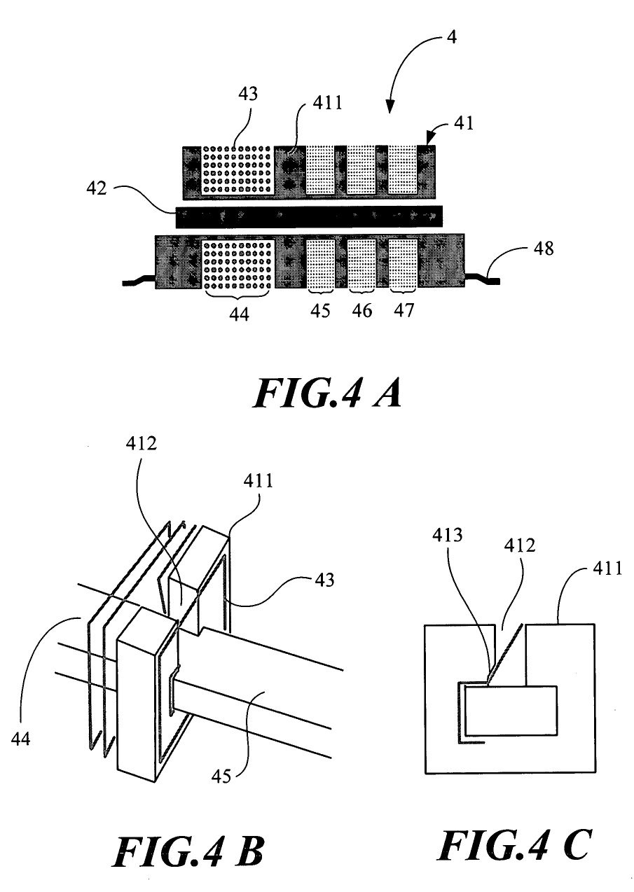

Referring to FIGS. 4A, 4B and 4C, a side view, partial view and partial side view of the high voltage transformer for a backlight power source according to a second embodiment of the present invention are illustrated, respectively. As shown, the transformer 4 is composed of a windings base 41, a core 42 and windings 43. Exterior to the windings base 41, a plurality of isolating walls 411 are disposed, on each of which a recess 412 having a guiding corner is formed. With provision of the isolating walls 411, a first windings trough 44 at a primary side region and a second windings trough 45, a third windings trough 46 and a fourth windings trough 47 at a secondary side region are separated from one another. In laying out the windings 43, the windings 43 are wound first on a bottom of the first windings trough 44 at a primary side region and then stridden onto the second windings trough 45 at a secondary side region through a recess 312 formed on the thick isolating wall 311 after the first windings trough 44 is full. Thereafter, the windings 43 are guided onto a bottom of the second windings trough 45 through the guiding corner 413 of the recess 412 and then wound layer by layer until the second, third and fourth windings trough 45,46,47 are all full. Finally, the windings 43 are fixed onto a windings fixation post 48. As such, the windings 43 of different voltages flown therein may be prevented from crossing and contacting with each other when being wound from one trough to an adjacent trough. Then, the core 42 is disposed within a hollow structure of the windings base 41 and the high voltage transformer 4 is thus completely formed.

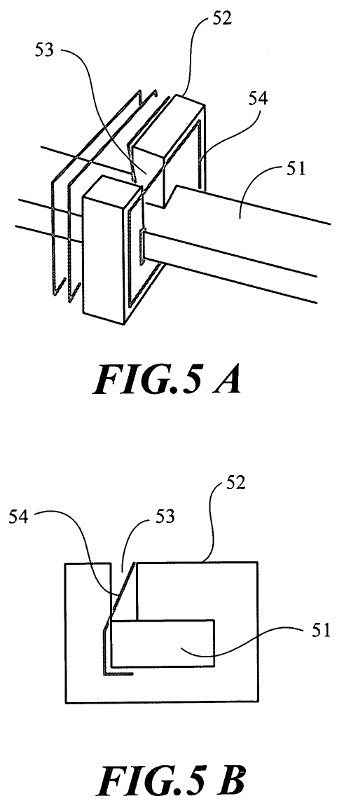

Referring to FIGS. 5A and 5B, a partial view, partial side view of the high voltage transformer for a backlight power source according to a fourth embodiment of the present invention are illustrated, respectively. As shown, a recess 53 is disposed at a position deviated from a main shaft body 51 on an isolating wall 53 of the transformer 5. In this case, windings 54 may not cross and contact with each other when being wound from one trough to an adjacent trough through the recess 53.

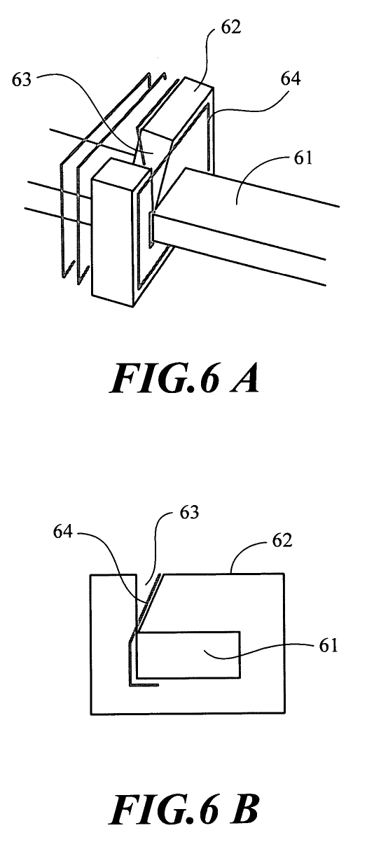

Referring to FIGS. 6A and 6B, a partial view, partial side view of the high voltage transformer for a backlight power source according to a fifth embodiment of the present invention are shown, respectively, therein. As shown, a recess 63 having a slanting surface is disposed at a position deviated from a main shaft body 61 on an isolating wall 63 of the transformer 6. In this case, windings 64 may not cross and contact with each other when being wound from one trough to an adjacent trough through the recess 63.

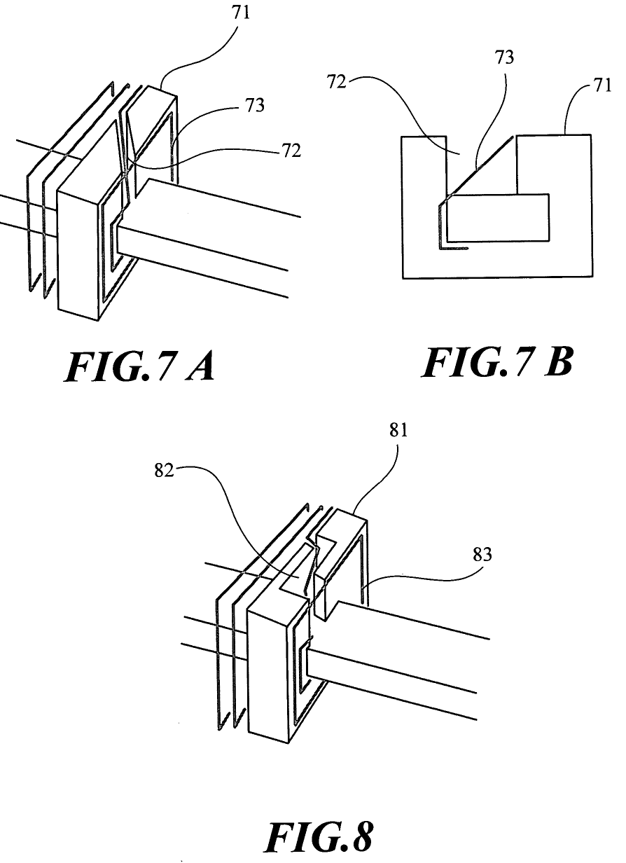

Referring to FIGS. 7A and 7B, a partial view, partial side view of the high voltage transformer for a backlight power source according to a sixth embodiment of the present invention are illustrated, respectively. As shown, a slantedly disposed recess 72 is disposed on an isolating wall 71. In this case, windings 73 may not cross and contact with each other when being wound from one trough to an adjacent trough through the slantedly disposed recess 72.

Referring to FIGS. 8A and 8B, a partial view, partial side view of the high voltage transformer for a backlight power source according to a seventh embodiment of the present invention are illustrated, respectively. As shown, a two-sectioned recess 82 is disposed on an isolating wall 81. In this case, windings 83 may not cross and contact with each other when being wound from one trough to an adjacent trough through the two-section recess 82.

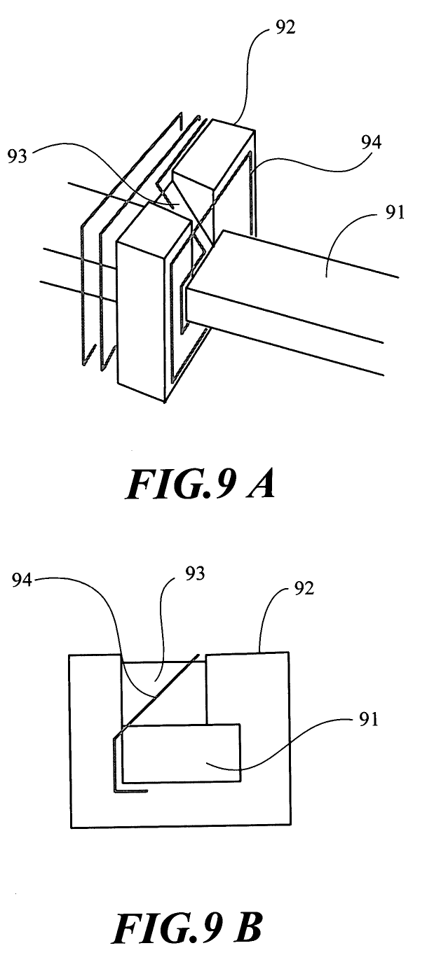

Referring to FIGS. 9A and 9B, a partial view, partial side view of the high voltage transformer for a backlight power source according to an eighth embodiment of the present invention are illustrated, respectively. As shown, a recess 93 is disposed on an isolating wall 92 having a predetermined thickness but not directly through. In the recess 93, a slanting surface is disposed along a direction of a main shaft body 91 In this case, windings 94 may not cross and contact with each other when being wound from one trough to an adjacent trough through the recess 93.

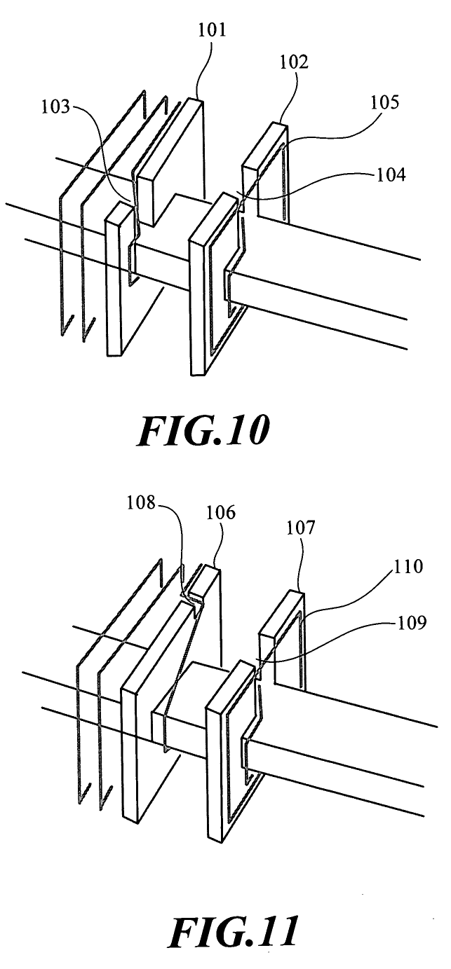

Referring to FIG. 10, a partial view of the high voltage transformer for a backlight power source according to an ninth embodiment of the present invention is illustrated. As shown, two recesses 103,104 are disposed on two isolating walls 101,102, respectively, of the transformer. The two recesses 103,104 are disposed along a diagonal direction with respect to the isolating walls 101,102. In this case, windings 105 may not cross and contact with each other when being wound from one trough to an adjacent trough through the recesses 103,104.

Referring to FIG. 11, a partial view of the high voltage transformer for a backlight power source according to a tenth embodiment of the present invention is illustrated. As shown, two recesses 108,109 are disposed on a first and second isolating walls 106,107, respectively, of the transformer. The recess 108 of the first isolating walls 106 is a concave while the recess 109 of the second isolating walls 107 is a fillister. The two recesses 108,109 are disposed along a diagonal direction with respect to the first and second isolating walls 106,107. In this case, windings 110 may not cross and contact with each other when being wound from one trough to an adjacent trough through the two recesses 108,109.

As compared to the prior art, the inventive high voltage transformer for a backlight power source provides the following advantages. 1. With the novel structural designs of the windings base, windings in the high voltage transformer may be wound upward layer by layer on the bottom of the windings trough when the windings are wound across the isolating wall, in prevention of windings of different voltages flown therein crossing and contacting with each other and thus a reduced voltage bearing ability of the transformer. 2. With the novel structural designs of the windings base, the distance generated from stacking of the windings is served to increase the bearing voltage and reduce length of the transformer, enhancing stability of the transformer. 3. The high voltage transformer provides the advantages of prolonged lifetime, lower cost, reduced dimension and space saving of the transformer.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A high voltage transformer for a backlight power source including a windings base, a core and windings, the windings base having isolating walls disposed exterior thereto through which a primary side region and a secondary side region are formed, the secondary side region being optionally formed with several windings troughs by using of the isolating walls and the windings being wound on the windings troughs, the windings being wound upward layer by layer on a bottom of the windings trough when the windings are wound across the isolating walls in prevention of the windings of different voltages flown therein crossing and contacting with each other and fixed onto a windings fixation post until the windings troughs are full, and the core being received within a hollow structure of the windings base.

2. The high voltage transformer according to claim 1, wherein a first windings trough, a spare trough and a second windings trough are formed by the isolating walls, the windings are first wounded on a bottom of the first windings trough at the primary side region and then stridden on the spare trough after the first windings trough is full and then guided through a recess of an isolating wall corresponding to the spare wall among the isolating walls to the second windings trough at the secondary side region and then wounded upward layer by layer on a bottom of the second windings trough and finally fixed onto the windings fixation post after the second windings trough is full.

3. The high voltage transformer according to claim 1, wherein a thick isolating wall is disposed exterior to the windings base and a first windings trough and a second windings trough are formed by the thick isolating wall, the windings are first wounded on a bottom of the first windings trough at the primary side region and then guided through a recess of the thick isolating wall to the second windings trough at the secondary side region after the first windings trough is full and then wounded upward layer by layer on a bottom of the second windings trough and finally fixed onto the windings fixation post after the second windings trough is full.

4. The high voltage transformer according to claim 1, wherein a plurality of isolating walls are disposed exterior to the windings base and each of the plurality of isolating walls has a recess having a guiding corner and wherein a windings trough at the primary side region and windings troughs at the secondary side region are formed by the plurality of isolating walls between which the windings are wound first on a bottom of the windings trough at the primary side region and then stridden onto the windings troughs at the secondary side region through a recess formed on the isolating wall between the windings trough at the primary side region and the windings troughs of the secondary side region after the windings trough at the primary side region is full and then guided through a recess of the thick isolating wall to the second windings trough at the secondary side region after the first windings trough is full and then wounded upward layer by layer on a bottom of another windings trough and finally fixed onto the windings fixation post after the another windings trough is full.

5. The high voltage transformer according to claim 1, wherein each of the isolating walls has a recess disposed at a position deviated from a main shaft body and in which the windings are guided.

6. The high voltage transformer according to claim 1, wherein each of the isolating walls has a recess having a slanted surface disposed at a position deviated from a main shaft body and in which the windings are guided.

7. The high voltage transformer according to claim 1, wherein each of the isolating walls has a slantedly disposed recess disposed at a position deviated from a main shaft body and in which the windings are guided.

8. The high voltage transformer according to claim 1, wherein each of the isolating walls has a two-sectioned recess.

9. The high voltage transformer according to claim 1, wherein each of the isolating walls has a predetermined thickness and a slanting surface disposed along a direction of a main shaft body and is not directly through.

10. The high voltage transformer according to claim 1, wherein the isolating walls are formed in a pair and each having a recess, the recesses in the pair of isolating walls being disposed along a diagonal direction with respect to the pair of isolating walls.

11. The high voltage transformer according to claim 1, wherein the isolating walls are formed in a pair and each having a recess, one isolating wall of the isolating wall pair being a concave while the other isolating wall of the isolating wall pair being a fillister and the isolating walls being disposed along a diagonal direction with respect to the isolating wall pair.
